(19) United States
(12) Patent Application Publication
(10) Pub. No.: US 2024/0416266 A1
(43) Pub. Date: Dec. 19, 2024

(54) SYSTEM AND METHOD FOR REDUCING AIRBORNE PATHOGENS AND CONTAMINANTS IN EXHALED AIR FROM A PERSON

(71) Applicant: MagPlasma, Inc., Brighton, MI (US)

(72) Inventors: Martin E. Toomajian, Brighton, MI (US); Timothy E. Moore, Port Saint Luce, FL (US)

(21) Appl. No.: 18/815,328

(22) Filed: Aug. 26, 2024

Related U.S. Application Data
(63) Continuation of application No. 17/227,347, filed on Apr. 11, 2021, now Pat. No. 12,109,523.
(60) Provisional application No. 63/010,054, filed on Apr. 15, 2020.

(51) Int. Cl. B01D 46/10; B01D 46/44; F24F 3/163

(52) U.S. Cl. CPC B01D 46/10; B01D 46/444; F24F 3/163; B01D 2265/028; B01D 2275/10; B01D 2279/65

(57) ABSTRACT

A system for reducing airborne pathogens and contaminants in exhaled air from a person. The system includes a collection device for collecting the exhaled air from the person; a purification device positioned in fluid communication with the collection device and being configured for receiving the exhaled air therefrom, said purification device deactivating and/or filtering airborne pathogens and contaminants in the exhaled air; and a suction device positioned in fluid communication with the purification device and the collection device, said suction device being configured for drawing the exhaled air from the collection device and through the purification device.

### CROSS-REFERENCE TO RELATED APPLICATIONS

This application is a continuation application of application Ser. No. 17/227,347, titled, Systems and Methods of Reducing Airborne Pathogens and Contaminants in a Breathing Zone, filed Apr. 11, 2021, which claims priority to U.S. Provisional Application Ser. No. 63/010,054, titled, Systems and Methods of Reducing Airborne Pathogens and Contaminants in a Patient Area, filed Apr. 15, 2020, hereby incorporated by reference in its entirety for all of its teachings.

### TECHNICAL FIELD

This invention relates to reducing airborne pathogens and contaminants. More specifically, this invention relates to reducing airborne pathogens and contaminants in the breathing zone of a person using utilizing entrapment and/or active neutralization technologies and employing a vacuum air intake assembly coupled with a manifold assembly to draw contaminated exhalation air from the person.

### BACKGROUND

America faces a serious threat to our personal and economic health due to new, highly contagious viruses, such as the COVID-19 virus, as well as numerous hospital acquired contagions. These contagions are spread by infected individuals (asymptomatic and symptomatic) via particle release from respiration, coughing, sneezing and subsequent surface contamination and contact or inhalation by a new host. A significant number of patients become seriously ill from the infection and require hospitalization, which increases the likelihood of exposure to healthcare workers and intra-hospital spread of the contagion. A smaller but still sizable number require the use of assisted breathing support via a manual or automated ventilator system due to complications from pneumonia. The recent COVID-19 outbreak demonstrates how easily existing hospital intensive care units (ICUs) and isolation wards can become overwhelmed when contagion dosages become concentrated enough to overcome healthcare workers' personal protective equipment. Hospital, and other healthcare facilities become overwhelmed when the high volume and density of patients ensures that hospitals and other treatment locations become significantly loaded with viral particles that can remain airborne for hours before coming to rest on various surfaces, thus multiplying the potential for exposure of medical staff and other patients.

### SUMMARY

Embodiments of the present invention attempt to reduce airborne pathogens and contaminants, such as viruses and bacteria, and subsequently reduce interior surface contamination through the use of a simple, portable system that utilizes entrapment and/or active neutralization technologies combined with a suction assembly, such as a vacuum pump or fan, to actively collect and draw away from infected people and patient exhaled air for the purposes of reducing room airborne contamination. Systems and methods of the present invention are available for use with any person who may be infectious or contaminated with a virus, bacterium, or other contagion, and may be used in any location loaded with viral particles such as, but not limited to, clinics, hospitals, nursing homes, bathrooms, offices, buildings, temporary structures, and personnel transport vehicles including ambulance, emergency medical treatment (EMT) vehicles, buses, taxis, law enforcement vehicles, and medivac aircraft.

In one embodiment of the present invention, a system for reducing airborne pathogens and contaminants in a breathing zone of a person is disclosed. The system includes a manifold assembly including a tube fitted with an air intake nozzle. The air intake nozzle is positioned at a breathing zone of the person such that an air gap is created between the person and the nozzle. Exhaled air is routed from the person to the manifold assembly via the tube. The system also includes a purification unit for purifying air by deactivating and/or filtering airborne pathogens and contaminants of the exhaled air supplied from the manifold assembly. The system further includes a suction assembly for drawing the exhaled air from the breathing zone of the person, through the manifold assembly and the purification unit, to a one-way exhaust valve.

In one embodiment, the system further comprises a pre-treatment filter coupled to an exit port of the manifold assembly, and a mass flow controller to adjust air flow of the pretreated exhaled air introduced into the purification unit for treatment to maintain a constant air flow rate or system pressure. In one embodiment, the system also comprises a posttreatment filter coupled between an outlet port of the suction assembly and an inlet of the exhaust valve.

The manifold assembly may comprise a multi-port valve coupled to the tube, wherein the tube has a first end coupled to the air intake valve and a second end coupled to the manifold assembly. The tube may be, but is not limited to, a polymer composite tube, a duct, or a hose assembly.

In some embodiments, the air intake nozzle is a snorkel having a nozzle end for directing the exhaled air from the breathing zone of the person into the tube. The air intake nozzle may be positioned between approximately one and ten inches from the breathing zone of the person, maintaining the air gap between the person and the nozzle.

The suction assembly may be a vacuum pump or a fan.

The airborne pathogens and contaminants are viruses, bacteria, or other microorganisms that can cause disease in humans. The viruses may be, but are not limited to, coronaviruses such as SARS-CoV-2.

The system may be portable or movable and used at one or more of the following settings or locations: clinics, hospitals, nursing homes, bathrooms, offices, buildings, temporary structures, and personnel transport vehicles including ambulances, emergency medical treatment (EMT) vehicles, buses, taxis, law enforcement vehicles, and medivac aircraft.

In another embodiment of the present invention, a method of reducing airborne pathogens and contaminants in a breathing zone of a person is disclosed. The method includes routing exhaled air from a breathing zone of a person through an air intake nozzle to a manifold assembly via a tube. The tube is coupled between an outlet of the nozzle and an inlet port of the manifold assembly. An air gap is created between the person and the nozzle. The method also includes deactivating and/or filtering airborne pathogens and contaminants of the exhaled air, supplied from the manifold assembly, using a purification unit. The method further includes drawing the exhaled air from the person, through the manifold assembly and the purification unit, to a one-way exhaust valve.

In some embodiments, the method also includes pre-treating the exhaled air from the manifold assembly prior to entry into the purification unit and adjusting air flow of the pretreated exhaled air introduced into the purification unit for treatment.

In some embodiments, the method further includes post-treating the exhaled air after exiting the purification unit prior to entry to the one-way exhaust valve.

In another embodiment of the present invention, a system for reducing airborne pathogens and contaminants in a breathing zone of a person is disclosed. The system includes a manifold assembly including a multi-port valve coupled to multiple tubes. Each tube is fitted with an air intake nozzle positioned at breathing zones of one or more persons such that an air gap is created between each person and each nozzle. Exhaled air is routed from each person to the manifold assembly via the tubes. The system also includes a purification unit for deactivating and/or filtering airborne pathogens and contaminants of the exhaled air supplied from the manifold assembly. The system further includes a suction assembly for drawing the exhaled air from each person, through the manifold assembly and the purification unit, to a one-way exhaust value.

### BRIEF DESCRIPTION OF THE DRAWINGS

FIG. 1 is a schematic diagram of a system for reducing airborne pathogens and contaminants in the breathing zone of a person, in accordance with one embodiment of the present invention.

FIG. 2 is a schematic diagram of a system for reducing airborne pathogens and contaminants in the breathing zone of a person, in accordance with one embodiment of the present invention.

FIG. 3 is a flowchart illustration of a method of reducing airborne pathogens and contaminants in the breathing zone of a person, in accordance with one embodiment of the present invention.

### DETAILED DESCRIPTION

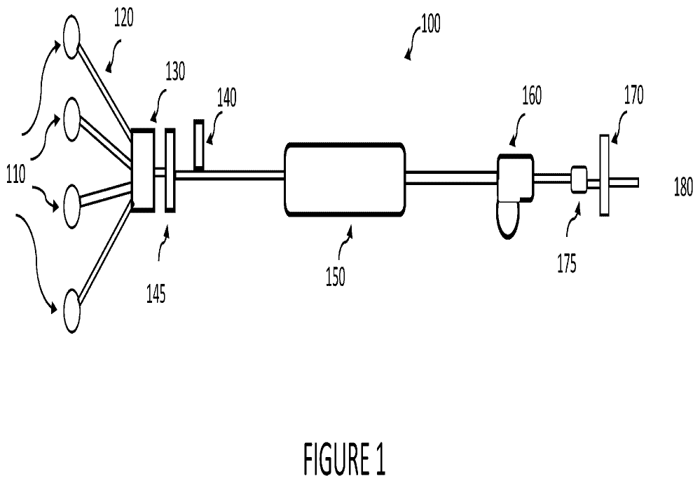

FIG. 1 is a schematic diagram of a system 100 for reducing airborne pathogens and contaminants in the breathing zone of a person, in accordance with one embodiment of the present invention. The system includes a manifold 130 with at least one port to permit coupling to one or more tubes 120. The tubes 120 may be flexible polymer tube, plastic tubes, or hoses, and each tube 120 is fitted with an air intake nozzle 110 positioned at a breathing zone of a person or patient (not shown in FIG. 1) for directing exhaled air from the person into the tubes 120. It should be noted that the manifold 130 can have one tube, two tubes, or three or more tubes, with each tube 120 fitted with an air intake nozzle 110.

The breathing zone is an area close the mouth and nostrils of a person, between one to ten inches of the person's face, and allows for an air gap between the person and the nozzle 110. Thus, the air intake nozzle 110 should be positioned close to the face of the person but not intrusive, and the placement of the nozzle 110 vis-n-vis the person will serve to reduce the amount of vacuum required to capture and move a contaminated air stream. In some embodiments, the air intake nozzle 110 is positioned within a few inches of the person. In another embodiment, the air intake nozzle 110 is positioned between one to six inches from a patient or a patient's intubation assembly.

The placement of the nozzle 110 at the breathing zone of the person may be accomplished by way of a clamp or other similar device. In some embodiments, the nozzle 110 is a snorkel having a nozzle end for directing exhaled air from the person into the tube 120.

The system 100 includes a purification unit for purifying air by deactivating and/or filtering airborne pathogens and contaminants of the exhaled air supplied from the manifold 130. In the embodiment of FIG. 1, the purification unit includes a HEPA (High Efficient Particle Air) pre-filter 145, a plasma reactor or chamber 150, and a HEPA post-filter 170. The HEPA pre-filter 145, arranged upstream of the plasma chamber 150, removes at least 95% of the particulates as small as 0.3 microns in size from the air stream. The plasma chamber 150, arranged between the HEPA pre-filter 145 and the HEPA post-filter 170, is able to inactivate or remove from the air stream 99.9% of the particulates, with the vast majority due to inactivation. Any remaining particles are removed or captured by the HEPA post-filter 170, which captures up to 99.9% of the most difficult particle to filter—size 0.3 micron particles—including viruses, bacteria, dust, pollen, and mold. A carbon filter 175 is included for the removal of odors and any remaining particles of contaminant from the air flow. By passing through the HEPA filters 145 and 170 and the plasma chamber 150, the purification unit diminishes a virus's ability to infect cells. A mass flow controller 140, positioned between the HEPA pre-filter 145 and the plasma chamber 150, adjusts the air flow which is introduced into the plasma chamber 150 for treatment of the exhaled air.

A vacuum pump 160 creates a pressure differential to draw the air stream through the components discussed herein. The pump 160 draws the exhaled air through the filters 145 and 170 and the pressure chamber 150, and returns filtered and treated air to an exhaust outlet 180 and back to the room, a HVAC unit, or to the atmosphere. The pressure differential is the main driving force for the movement of the air stream within the system, and the vacuum pump 160 is capable of creating sufficient negative pressure through the tubes 120 to prevent or reduce free release of viral laden exhaled air. It should be noted that one or more of the filters 145, 170, 175, including the plasma chamber 150, may be optional and positioned at different locations of the system.

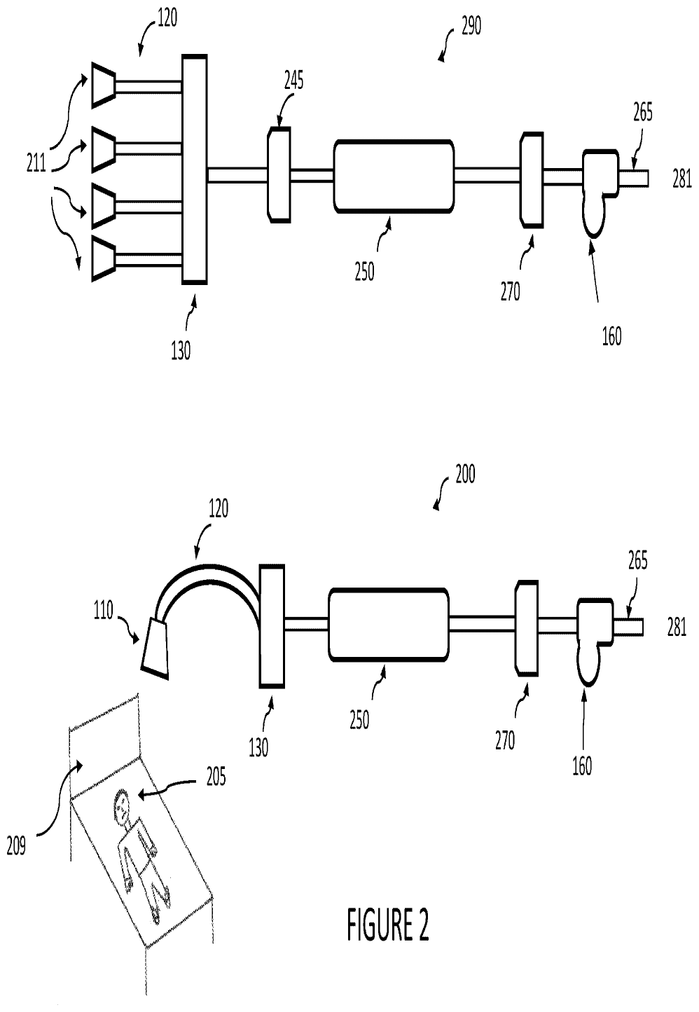

FIG. 2 is a schematic diagram of a system 200 for reducing airborne pathogens and contaminants in the breathing zone of a person, in accordance with one embodiment of the present invention. In the embodiment shown at the bottom of the diagram, an air intake exhaust 110 or nozzle is placed near the headboard 209 area of a patient 205 for directing exhaled air from the patient 205 to an exhaust hose assembly or tube 120. The tube 120, which is coupled to a manifold 130, routes the air from the patient 205 location through a first filter 145 (FIG. 1), an active destruction unit 250, and a second filter 270. The one or more filters 145 (FIG. 1) and 270 may be a HEPA/ULPA filter. The active destruction unit 250 may be a plasma reactor or chamber. The vacuum pump 160 draws the exhaled air through the filters 145 (FIG. 1) and 270 and the active destruction unit 250 and returns filtered and treated air to the patient treatment area 281 or, alternatively, to the atmosphere or to an air handling unit, via an exhaust line 265.

Still referring to FIG. 2, in the embodiment shown at the top of diagram, the system 290 is incorporated to include multiple air intake nozzles 110 to draw exhaled air from multiple patients in a treatment area 211 using one or more hoses or tubes 120 coupled a manifold 130. The exhaled air collected from the multiple patients is then routed through a first stage particulate filter 245, an active destruction unit 250 which may be, but is not limited to, a plasma unit, and a second stage particulate filter 270. The vacuum pump 160, which draws the exhaled air through the filters 245 and 270 and active destruction unit 250, exhausts the treated air to the atmosphere 281, back to the patient treatment area, or to an air handling unit, via an exhaust line 265.

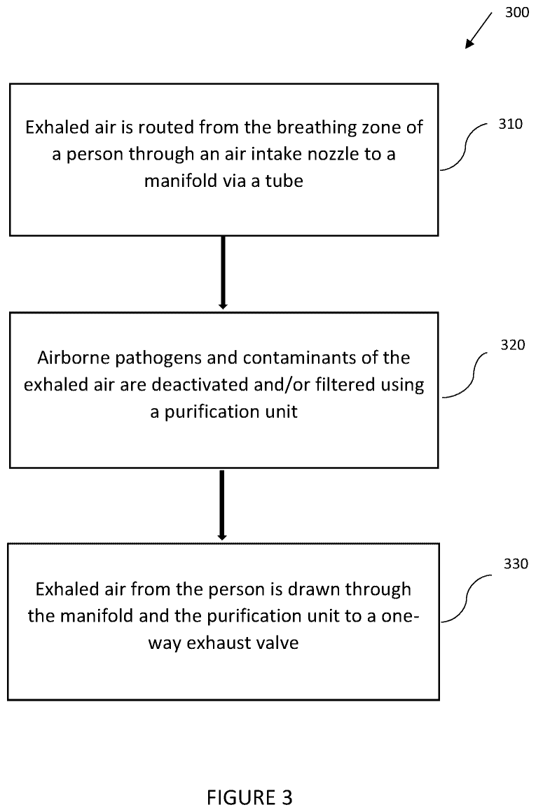

FIG. 3 is a flowchart 300 illustration of a method of reducing airborne pathogens and contaminants in the breathing zone of a person, in accordance with one embodiment of the present invention. In 310, exhaled air is routed from the breathing zone of a person through an air intake nozzle to a manifold assembly via a tube. Next, in 320, airborne pathogens and contaminants of the exhaled air are deactivated and/or filtered using a purification unit. Exhaled air from the person is drawn through the manifold and the purification unit to a one-way exhaust valve, in 330.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

We claim:

1. A system for reducing airborne pathogens and contaminants in exhaled air from a person, said system comprising:
a collection device for collecting the exhaled air from the person;
a purification device positioned in fluid communication with the collection device and being configured for receiving the exhaled air therefrom, said purification device deactivating and/or filtering airborne pathogens and contaminants in the exhaled air; and
a suction device positioned in fluid communication with the purification device and the collection device, said suction device being configured for drawing the exhaled air from the collection device and through the purification device.

2. The system according to claim 1 wherein the purification device is a plasma reactor.

3. The system according to claim 1 further comprising a pre-filter positioned in fluid communication with the collection device and being configured for receiving the exhaled air therefrom before the exhaled air is received by the purification device, said pre-filter removing particulates from the exhaled air.

4. The system according to claim 1 further comprising a post-filter positioned in fluid communication with the purification device and being configured for receiving the exhaled air therefrom, said post-filter removing particulates from the exhaled air.

5. The system according to claim 1 further comprising a carbon filter positioned in fluid communication with the collection device and being configured for receiving the exhaled air therefrom, said carbon filter removing odors from the exhaled air.

6. The system according to claim 1 further comprising a flow controller positioned in fluid communication with the collection device and being configured for receiving the exhaled air therefrom, said flow controller providing a constant flow rate or system pressure of the exhaled air to the purification device.

7. The system according to claim 1 wherein the collection device includes multiple intake tubes for collecting the exhaled air.

8. The system according to claim 1 wherein the suction device is a vacuum pump or a fan.

9. A method for reducing airborne pathogens and contaminants in exhaled air from a person, said method comprising:
collecting the exhaled air from the person by a collection device;
deactivating and/or filtering airborne pathogens and contaminants in the exhaled air by a purification device that receives the collected exhaled air from the collection device; and
drawing the exhaled air from the collection device through the purification device by a suction device.

10. The method according to claim 9 wherein the purification device is a plasma reactor.

11. The method according to claim 9 further comprising removing particulates from the exhaled air by a pre-filter before the exhaled air is received by the purification device.

12. The method according to claim 9 further comprising removing particulates from the exhaled air by a post-filter after the exhaled air is purified by the purification device.

13. The method according to claim 9 further comprising removing odors from the exhaled air by a carbon filter.

14. The method according to claim 9 further comprising providing a constant flow rate or system pressure of the exhaled air to the purification device by a flow controller.

15. The method according to claim 9 wherein collecting the exhaled air from the person by a collection device includes collecting the exhaled air through multiple intake tubes.

16. A system for reducing airborne pathogens and contaminants in exhaled air from a person, said system comprising:
a collection device for collecting the exhaled air from the person;
a pre-filter positioned in fluid communication with the collection device and being configured for receiving the exhaled air therefrom, said pre-filter removing particulates from the exhaled air;
a plasma reactor positioned in fluid communication with the collection device and the pre-filter and being configured for receiving the exhaled air therefrom, said plasma reactor deactivating and/or filtering airborne pathogens and contaminants in the exhaled air;
a post-filter positioned in fluid communication with the plasma reactor and being configured for receiving the exhaled air therefrom, said post-filter removing particulates from the exhaled air; and
a suction device positioned in fluid communication with the collection device, the pre-filter, the plasma reactor and the post-filter, said suction device being configured for drawing the exhaled air from the collection device and through the pre-filter, the plasma reactor and the post-filter.

17. The system according to claim 16 further comprising a carbon filter positioned in fluid communication with the collection device and being configured for receiving the exhaled air therefrom, said carbon filter removing odors from the exhaled air.

18. The system according to claim 16 further comprising a mass flow controller positioned in fluid communication with the collection device and being configured for receiving the exhaled air therefrom, said mass flow controller providing a constant flow rate or system pressure of the exhaled air to the plasma reactor.

19. The system according to claim 16 wherein the collection device includes multiple intake tubes for collecting the exhaled air.

20. The system according to claim 16 wherein the post-filter removes 0.3 micron sized particles.
